(19) United States
(12) Patent Application Publication
(10) Pub. No.: US 2024/0178913 A1
(43) Pub. Date: May 30, 2024

(54) APPARATUS FOR AND METHOD OF PERFORMING HIGH-CAPACITY WIRELESS COMMUNICATION IN A GREENHOUSE ENVIRONMENT

(71) Applicant: ELECTRONICS AND TELECOMMUNICATIONS RESEARCH INSTITUTE, Daejeon (KR)

(72) Inventor: Jaeyoung KIM, Daejeon (KR)

(73) Assignee: ELECTRONICS AND TELECOMMUNICATIONS RESEARCH INSTITUTE, Daejeon (KR)

(21) Appl. No.: 18/485,085

(22) Filed: Oct. 11, 2023

(30) Foreign Application Priority Data
Nov. 24, 2022 (KR) 10-2022-0159029

(51) Int. Cl. H04B 7/26; A01G 9/14; H04L 43/10

(52) U.S. Cl. CPC H04B 7/2606; A01G 9/14; H04L 43/10

(57) ABSTRACT

Proposed is an apparatus for performing high-capacity wireless communication in a greenhouse environment, the apparatus including: a moving enabling control unit including a motor for moving at least one wireless router in an upper end portion of a greenhouse, a moving enabling module including a motor control module and a motor communication module, and a moving enabling rails installed in a predetermined number, length and direction at the upper end portion of the greenhouse, and a greenhouse integrated control unit configured to set an interval of movement of the wireless router by communicating with the motor communication module and to generate and transmit a control command for controlling the motor control module in such a manner that the wireless router moves at the set interval of movement.

### CROSS-REFERENCE TO RELATED APPLICATION

This application claims priority to and the benefit of Korean Patent Application No. 10-2022-0159029, filed on Nov. 24, 2022, the disclosure of which is incorporated herein by reference in its entirety.

### BACKGROUND

### 1. Technical Field

The present disclosure relates to an apparatus for and a method of performing high-capacity wireless communication in a greenhouse environment.

### 2. Related Art

wired lines have been utilized in communication between sensor/driver nodes or in communication with a greenhouse integrated controller because the reliability of wireless communication within a greenhouse is not ensured in the related art.

Techniques for applying wireless communication in a greenhouse have been tried intermittently in the related art. However, the frequent occurrence of packet loss due to crops or obstacles makes it difficult to apply the wireless communication.

### SUMMARY

An object of the present disclosure is to provide an apparatus for and a method of performing high-capacity wireless communication in a greenhouse environment. The apparatus and the method are capable of performing high-capacity wireless communication without being affected by crops and obstacles, by installing and controlling a movable wireless router in an upper end portion of a greenhouse in which the crops and the obstacles are almost not present.

However, the present disclosure is not limited to the above-mentioned object. From the heading “DETAILED DESCRIPTION,” an object not mentioned above would be apparent to a person of ordinary skill in the art to which the present disclosure pertains.

In order to accomplish the above-mentioned object, according to an aspect of the present disclosure, there is provided an apparatus for performing high-capacity wireless communication in a greenhouse environment, the apparatus including: a moving enabling control unit comprising a motor for moving at least one wireless router in an upper end portion of a greenhouse, a moving enabling module including a motor control module and a motor communication module, and a moving enabling rails installed in a predetermined number, length and direction at the upper end portion of the greenhouse; and a greenhouse integrated control unit configured to set an interval of movement of the wireless router by communicating with the motor communication module and to generate and transmit a control command for controlling the motor control module in such a manner that the wireless router moves at the set interval of movement.

In order to accomplish the above-mentioned object, according to another aspect of the present disclosure, there is provided a method of performing high-capacity wireless communication in a greenhouse environment, the method including: establishing a connection by communicating with a moving enabling module for moving at least one wireless router located in an upper end portion of a greenhouse; setting an interval of movement of the wireless router through the motor communication module; generating a control command for the wireless router to move at the set interval of movement; and transmitting the generated control command to the moving enabling module. In the method, the moving enabling module may includes a motor for moving the wireless router along a moving enabling rails installed in a predetermined number, length and direction at the upper end portion of the green; and a motor control module.

In order to accomplish the above-mentioned object, according to still another aspect of the present disclosure, there is provided a computer program, stored on a computer-readable medium, for performing the method of performing high-capacity wireless communication in a greenhouse environment.

Further details of the present disclosure are described with reference to the accompanying drawings under the heading “DETAILED DESCRIPTION.”

In the apparatus for and the method of performing high-capacity wireless communication in a greenhouse environment, the reliability of data can be ensured when data are wirelessly communicated within a greenhouse, thereby providing the advantage of possibly performing exact complex environmental control within the greenhouse.

Moreover, since wireless communication is utilized within the greenhouse, installation costs are incurred less than when using wired lines. A sensor can be readily added or replaced. The apparatus can be installed without any limitations in place, and flexibility in control can be ensured.

The present disclosure is not limited to the above-mentioned effects. From the heading “DETAILED DESCRIPTION, an effect not mentioned above would be apparent to a person of ordinary skill in the art to which the present disclosure pertains.

### BRIEF DESCRIPTION OF THE DRAWINGS

FIG. 1 is a diagram that is referred to for description of an apparatus for performing high-capacity wireless communication according to a first embodiment of the present disclosure.

FIG. 2 is a diagram that is referred to for description of a moving enabling control unit according to the first embodiment of the present disclosure.

FIG. 3 is a diagram that is referred to for description of an internal configuration of a greenhouse integrated control unit according to the first embodiment of the present disclosure.

FIG. 4 is a flowchart that is referred to for description of a method of performing high-capacity wireless communication according to a second embodiment of the present disclosure.

### DETAILED DESCRIPTION

Advantages and features of the present disclosure, and methods of achieving the advantages and the features will be apparent from embodiments that will be described in detail below with reference to the accompanying drawings. However, the present disclosure is not limited to the embodiments that will be disclosed below and can be implemented in various different forms. The embodiments are only provided to make the present disclosure complete and to provide definite notice as to the scope of the present disclosure to a person of ordinary skill in the art to which the present disclosure pertains. The scope of the present disclosure should be only defined by the claims.

The terms used in the present specification are the ones for describing the embodiments of the present disclosure and therefore are not intended to impose a limitation on the present disclosure. Unless specified otherwise throughout the present specification, a singular noun or a singular noun phrase may have a plural meaning. The terms “comprise” and/or “comprising” used in the specification should be construed to mean “including the following constituent element, but not excluding the presence or addition of one or more other constituent elements.” Throughout the specification, the same reference numeral refers to the same component, and the phrase “and/or” is interpreted to include each and all combinations of one or more of the earlier mentioned components. Although used to describe various constituent elements, the terms first, second, and so on do not impose any limitation on the terms. These terms are used to distinguish one constituent component from one or more other constituent components. Therefore, a first constituent element described below may be termed a second constituent element, provided such terms remain consistent with the scope of the technical concept of the present disclosure.

Unless otherwise defined, throughout the specification, all terms (including technical and scientific terms) may be used in a sense that can be commonly understood by a person of ordinary skill in the art to which the present disclosure pertains. In addition, unless otherwise explicitly defined in the specification, a term as defined in commonly used dictionaries should not be construed as having an excessively implied meaning or a purely literal meaning.

The present disclosure relates to an apparatus 1 for and a method of performing high-capacity wireless communication in a greenhouse environment.

Under the greenhouse environment, high-speed wireless communication may be performed between multiple apparatuses, including image sensors, environmental sensors, personal portable terminals, robots, drones, and the like. Furthermore, these apparatuses may transmit and receive a large amount of data to and from a greenhouse control system. In these cases, an error in data transmission and reception may occur due to crops or obstacles.

In order to alleviate this problem, a wireless router 300 according to a first embodiment of the present disclosure, that is capable of communicating a large amount of information is installed on the top portion of a greenhouse in a manner that allows it to move along a moving enabling rail 120. This installation provides the advantage of enabling high-speed wireless communication without being disturbed by crops and obstacles.

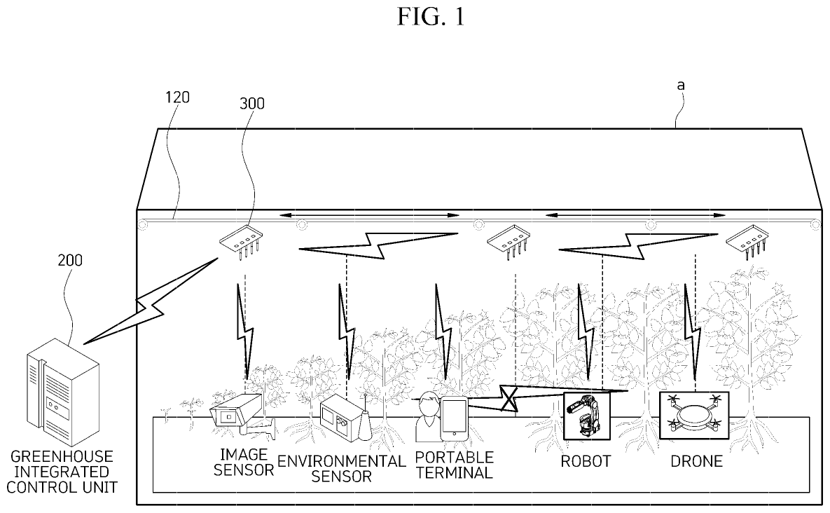

The apparatus 1 for performing high-capacity wireless communication in a greenhouse environment according to the first embodiment of the present disclosure will be described below with reference to FIGS. 1 to 3.

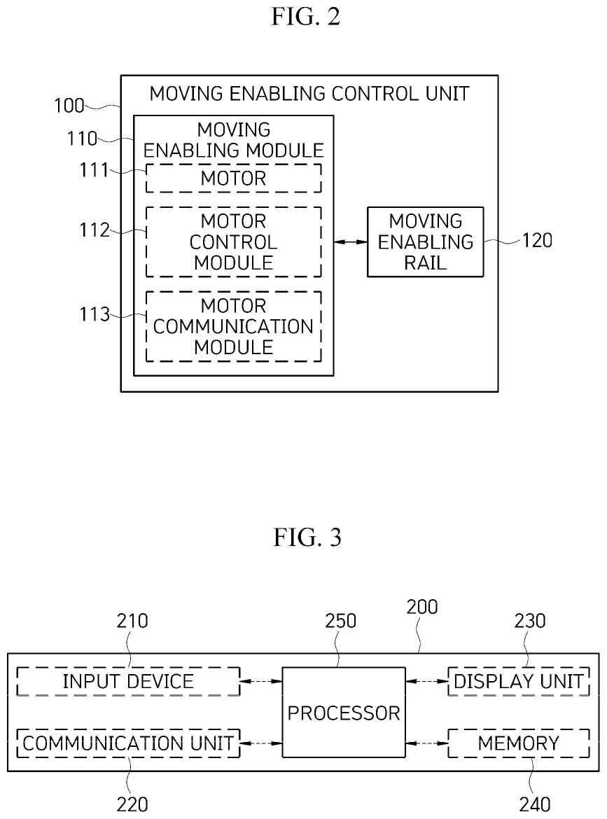

FIG. 1 is a diagram that is referred to for description of the apparatus 1 for performing high-capacity wireless communication according to the first embodiment of the present disclosure. FIG. 2 is a diagram that is referred to for description of a moving enabling control unit 100 according to the first embodiment of the present disclosure. FIG. 3 is a diagram that is referred to for description of an internal configuration of a greenhouse integrated control unit 200 according to the first embodiment of the present disclosure.

The apparatus 1 for performing high-capacity wireless communication according to the first embodiment of the present disclosure includes the moving enabling control unit 100 and a greenhouse integrated control unit 200.

The moving enabling control unit 100 includes a moving enabling module 110 and the moving enabling rail 120.

According to the first embodiment of the present disclosure, the moving enabling module 110 includes a motor 111 for moving at least one wireless router 300 in the upper end portion of the greenhouse, a motor control module 112 for controlling the motor 111, and a motor communication module 113.

In the case, according to the first embodiment of the present disclosure, the wireless router 300 may transmit and receive sensing information or control information through wireless communication among multiple sensor and driver nodes and various terminals (portable terminals, drones, robots, and the like) within the greenhouse or through wireless communication with the greenhouse integrated control unit 200 within the greenhouse.

The greenhouse integrated control unit 200 sets an interval of movement of the wireless router 300 by communicating with the motor communication module 113. Then, the greenhouse integrated control unit 200 generates a control command for controlling the motor control module 112 and transmits the generated control command to the moving enabling control unit 100 in such a manner that the wireless router 300 moves at the set interval of movement.

In accordance with this control command, the motor control module 112 can control the motor 111 so that the wireless router 300 can repeatedly move at the interval of movement along the moving enabling rail 120.

As an implementation example, the greenhouse integrated control unit 200 may transmit a control command for designating a location of the wireless router 300 to the motor communication module 113. Accordingly, when receiving the control command through the motor communication module 113, the motor control module 112 may control the motor 111 in such a manner that the wireless router 300 moves to the designated location that corresponds to the control command.

According to the first embodiment of the present disclosure, the wireless router 300 may include at least one stationary wireless router 300 and at least one moving wireless router 300 that is controlled to move along the moving enabling rail 120.

As an implementation example, the stationary or moving wireless router 300 ensures predetermined coverage. The moving wireless router 300 is controlled to move along the moving enabling rail 120, on the basis of coverage information of the stationary wireless router 300 or another moving wireless router 300.

For example, the greenhouse integrated control unit 200 stores the coverage information of the moving wireless router 300 and that of the stationary wireless router 300. The greenhouse integrated control unit 200 may control a movement of a specific moving wireless router 300 along the moving enabling rail 120, in such a manner that the specific moving wireless router 300 does not enter a predetermined distance range from the center of each of the stationary wireless router 300 and another moving wireless routers 300.

That is, the stationary wireless router 300 has a fixed coverage area. Thus, the greenhouse integrated control unit 200 controls the moving wireless router 300 in such a manner that the predetermined coverage area does not overlap a coverage area that another wireless router has. Thus, with the number of moving wireless routers 300 that is as small as possible, it is possible to perform wireless communication within all portions of the entire greenhouse.

At this time, in a case where the stationary wireless router 300 cannot perform wireless communication due to a disruption in communication, the greenhouse integrated control unit 200 may generate a control command for the moving wireless router 300 to enter a predetermined distance range from the center of the fixed coverage that the stationary wireless router 300 ensures.

As an implementation example, the greenhouse integrated control unit 200 may set paths along which a plurality of moving wireless router 300 move, on the basis of information on a connection between the moving wireless router 300, and a node and a terminal.

For example, the greenhouse integrated control unit 200 may generate first movement path information on the basis of first connection information on a connection with at least one terminal and node. The first information on connection is collected at a real-time or predetermined interval at which a first moving wireless router moves along a first moving enabling rail.

The greenhouse integrated control unit 200 may generate second movement path information on the basis of second connection information for connecting a terminal and a node, among terminals and nodes within the greenhouse, that are not associated with the first connection information, to a second moving wireless router that moves along a second moving enabling rail.

The greenhouse integrated control unit 200 may transmit a control command to the moving enabling control unit 100 on the basis of the first movement path information and the second movement path information that are generated in this manner.

In addition, according to the first embodiment of the present disclosure, in a case where the first movement path information and the second movement path information overlap and in a case where at least one section of the coverage that first moving wireless router ensures and at least one section of the coverage that second moving wireless router ensures overlaps, the greenhouse integrated control unit 200 may assign different weights to the first movement path information and the second movement path information, respectively, to perform control in the overlapping paths and in the overlapping sections. At this time, the weights may be determined on the basis of at least one of performance of the moving wireless router 300, a coverage area that the moving wireless router 300 has, a speed at which the moving wireless router 300 moves, and an interval at which the moving wireless router 300 moves.

According to the first embodiment of the present disclosure, the greenhouse integrated control unit 200 may check an operating state of the moving enabling control unit 100 through periodic heartbeat communication with the motor communication module 113.

For example, in a case where the greenhouse integrated control unit 200 does not receive a response from the motor communication module 113 as a result of the heartbeat communication, the greenhouse integrated control unit 200 may retransmit a heartbeat message a predetermined number of times at a predetermined time interval.

At this point, when it is impossible to communicate with the motor communication module 113 after retransmitting the heartbeat message, the greenhouse integrated control unit 200 may generate communication failure information and alarm information for alerting about the motor communication module 113.

With reference to FIG. 2, the greenhouse integrated control unit 200 according to the first embodiment of the present disclosure includes an input device 210, a communication unit 220, a display unit 230, a memory 240, and a processor 250.

The input device 210 generates input data in response to user input. Examples of the user input may include user input of data that are processed.

At least one input device 210 is provided. Examples of the input device 210 may include a key board, a key pad, a dome switch, a touch panel, a touch key, a mouse, and a menu button, and the like.

Internal constituent elements transmit and receive data to and from each other though the communication unit 220. The communication unit 220 performs communication with the moving enabling control unit 100 and external apparatuses, such as an external server. The communication unit 220 may include both a wired communication module and a wireless communication module. The wired communication module may be implemented as a power line communication device, a telephone line communication device, a CableHome (MoCA) device, an Ethernet device, an IEEE 1294 device, an integrated wired home network, and an RS-485 control device. In addition, the wireless communication module may be configured as a module that complies with communication standards, such as wireless LAN (WLAN) technology, Bluetooth, HDR WPAN, UWB, ZigBee, Impulse Radio, 60 GHz WPAN, Binary-CDMA, wireless USB technology, wireless HDMI technology, 5th generation communication, Long-Term Evolution-Advanced (LTE-A), Long-Term Evolution (LTE), and Wireless Fidelity (Wi-Fi).

Display data that result from the operation of the greenhouse integrated control unit 200 are displayed on the display unit 230. For example, locations of the wireless routers 300, setting information in accordance with the control command, information on the connection between the terminal and the node, and the like may be displayed on the display unit 230.

Examples of the display unit 230 includes a liquid crystal display (LCD), a light emitting diode (LED) display, an organic light emitting diode (organic LED) (OLED) display, a micro-electro-mechanical systems (MEMS) display, and an electronic paper display. The display unit 230 may be integrally combined with a touch screen.

Programs for driving the greenhouse integrated control unit 200 are stored in the memory 240. The memory 240 here collectively refers collectively to a non-volatile device and a volatile device that retain stored information even when electric power is not supplied thereto. Examples of the memory 240 may include NAND flash memories, such as a compact flash (CF) card, a secure digital (SD) card, a memory stick, a solid-state drive (SSD), and a micro SD card, magnetic computer storage devices, such as a hard disk driver (HDD), and optical disc drivers, such as a CD-ROM and a DVD-ROM.

By executing a software application, such as a program, the processor 250 may control at least one different constituent element (for example, a hardware or software constituent element) of the greenhouse integrated control unit 200 and may perform various types of data processing and various computations.

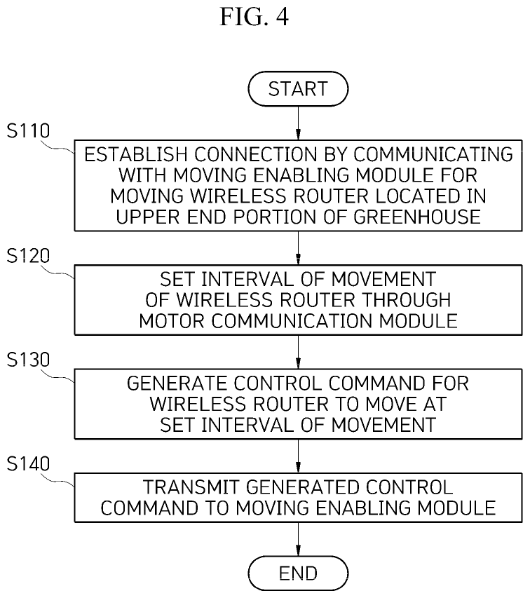

A method of performing high-capacity wireless communication according to a second embodiment of the present disclosure will be described with reference to FIG. 4. The method is performed by the apparatus 1 for performing high-capacity wireless communication in a greenhouse environment according to the first embodiment.

FIG. 4 is a flowchart that is referred to for description of the method of performing high-capacity wireless communication according to the second embodiment of the present disclosure.

First, the greenhouse integrated control unit 200 establishes a connection by communicating with the moving enabling module 110 for moving at least one wireless router 300 located in the upper end portion of the greenhouse (S110).

Next, the greenhouse integrated control unit 200 sets an interval of movement of the wireless router 300 through the motor communication module 113 (S120)

Next, the greenhouse integrated control unit 200 generates a control command for the wireless router 300 to move at the set interval of movement (S130) and transmits the generated control command to the moving enabling module 110 (S140)

As an implementation example of the present disclosure, each of Steps S110 to S140 described above may be divided into sub-steps or may be a combination of sub-steps. In addition, one or several of Steps S110 to S140 may be omitted, and the order of Steps S110 to S140 may be changed. In addition, although omitted, the description in FIGS. 1 to 3 may apply to FIG. 4, and the description in FIG. 4 may apply to FIGS. 1 to 3.

The method according to the second embodiment of the present disclosure, performed by the apparatus for performing high-capacity wireless communication in a greenhouse environment according to the first embodiment, may be realized as a program (or an application) in order to be executed in a state of being embedded into hardware, such as a computer. This realized method may be stored on a medium.

The above-mentioned program may include codes written in a computer language, such as C, C++, Java, Ruby, and a machine language, which is readable by a processor (CPU) in the computer through a device interface in the computer, in order for the computer to read the program and implement the method realized as the program. These codes may include functional codes associated with a function or the like that defines functions necessary to perform the method and may include control codes associated with an execution procedure necessary for the processor in the computer to perform the functions according to a predetermined procedure. In addition, these codes may further include codes, associated with memory reference, that indicate at which position (address) in an internal or external memory in the computer, additional information or a medium necessary for the processor in the computer is referenced to perform the functions. In addition, in a case where communication with any other computer or server that is remotely located is necessary in order for the processor in the computer to perform the functions, the codes may further include communication-associated codes that indicates how communication with any other computer or sever that is remotely located is performed using a communication module in the computer, which information or a medium is transmitted or received while the communication is performed, and the like.

The medium on with the program is stored refers to a computer-readable medium on which data are stored semi-permanently, instead of a medium, such as a register, a cache, or a memory, on which data are stored for a short moment. Specifically, examples of the medium on which the program is stored include a ROM, a RAM, a CD-ROM, a magnetic tape, a floppy disk, an optical data storage device, and the like, but is not limited to these. That is, the program may be stored on various recording media in various servers to which the computer can make a connection, or various media in a user's computer. In addition, the media are distributed to computer systems connected to each other over a network, and the computer-readable codes may be stored thereon in a distributed manner.

The embodiments of the present disclosure are described above in an exemplary manner. It would be apparent to a person of ordinary skill in the art to which the present disclosure pertains that the embodiments of the present disclosure are readily modified into specific forms without changing the technical idea of the present disclosure and essential features thereof. Therefore, in every aspect, the embodiments described above should be understood as being exemplary and non-restrictive. For example, the constituent elements that are described as having their respective single forms may be implemented in a distributed manner, and likewise, the constituent elements that are described as being distributed may be implemented in a combined manner.

The scope of the present disclosure is defined by the following claims rather than by the detailed description provided above. All modifications or alterations that are derived from the meaning of each element of the claims and the scope of the claims and from any equivalents thereto should be interpreted as falling within the scope of the present disclosure.

What is claimed is:

1. An apparatus for performing high-capacity wireless communication in a greenhouse environment, the apparatus comprising:
a moving enabling control unit comprising a motor for moving at least one wireless router in an upper end portion of a greenhouse, a moving enabling module including a motor control module and a motor communication module, and a moving enabling rails installed in a predetermined number, length and direction at the upper end portion of the greenhouse; and
a greenhouse integrated control unit configured to set an interval of movement of the wireless router by communicating with the motor communication module and to generate and transmit a control command for controlling the motor control module in such a manner that the wireless router moves at the set interval of movement.

2. The apparatus of claim 1, wherein the greenhouse integrated control unit transmits a control command for designating a location of the wireless router to the motor communication module, and
wherein, when receiving the control command through the motor communication module, the motor control module controls the motor in such a manner that the wireless router moves to the designated location that corresponds to the control command.

3. The apparatus of claim 1, wherein the wireless router includes at least one stationary wireless router and at least one moving wireless router that is controlled in such a manner as to move along the moving enabling rail.

4. The apparatus of claim 1, wherein the greenhouse integrated control unit checks an operating state of the moving enabling control unit through periodic heartbeat communication with the motor communication module.

5. The apparatus of claim 4, wherein, in a case where the greenhouse integrated control unit does not receive a response from the motor communication module as a result of the heartbeat communication, the greenhouse integrated control unit retransmits a heartbeat message a predetermined number of times at a predetermined time interval.

6. The apparatus of claim 5, wherein when it is impossible to communicate with the motor communication module after retransmitting the heartbeat message, the greenhouse integrated control unit generate communication failure information and alarm information for alerting about the motor communication module.

7. A method of performing high-capacity wireless communication in a greenhouse environment, the method comprising:
establishing a connection by communicating with a moving enabling module for moving at least one wireless router located in an upper end portion of a greenhouse;
setting an interval of movement of the wireless router through the motor communication module;
generating a control command for the wireless router to move at the set interval of movement; and
transmitting the generated control command to the moving enabling module,
wherein the moving enabling module includes a motor for moving the wireless router along a moving enabling rails installed in a predetermined number, length and direction at the upper end portion of the green; and
a motor control module.

8. The method of claim 7, wherein the generating of the control command for the wireless router to move at the set interval of movement comprises:
generating a control command for designating a location of the wireless router,
wherein when receiving the control command through the motor communication module, the motor control module controls the motor in such a manner that the wireless router moves at a designated location that corresponds to the control command.

9. The method of claim 7, wherein the wireless router includes at least one stationary wireless router and at least one moving wireless router that is controlled to move along the moving enabling rail.

10. The method of claim 7, further comprising:
checking an operating state of the moving enabling control unit, through periodic heartbeat communication with the motor communication module.

11. The method of claim 10, in the checking of the operating state of the moving enabling control unit, through the periodic heartbeat communication with the motor communication module, in a case where a response is not received from the motor communication module as a result of the heartbeat communication, a heartbeat message is retransmitted a predetermined number of times at a predetermined time interval.

12. The method of claim 11, wherein in the checking of the operating state of the moving enabling control unit, through the periodic heartbeat communication with the motor communication module, when it is impossible to communicate with the motor communication module after retransmitting the heartbeat message, communication failure information and alarm information that alert about the motor communication module are generated.
